(19) United States
(12) Patent Application Publication
(10) Pub. No.: US 2010/0128622 A1
(43) Pub. Date: May 27, 2010

(54) RADIO COMMUNICATION METHOD AND RADIO COMMUNICATION APPARATUS

(75) Inventors: Ayako Horiuchi, Kanagawa (JP); Katsuhiko Hiramatsu, Leuven (BE)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/598,332

(22) PCT Filed: May 8, 2008
(86) PCT No.: PCT/JP2008/001161

§ 371 Date: Oct. 30, 2009

(30) Foreign Application Priority Data
May 11, 2007 (JP) P2007-126678

(51) Int. Cl. H04L 12/26; H04B 7/14

(52) U.S. Cl. 370/252; 370/315

(57) ABSTRACT

A radio communication method and a radio communication apparatus that allow enhancement of a throughput characteristic and a degree of multiplicity of an MCS without a necessity for a special additional function. A channel quality measurement section 21 measures the quality of a channel from a mobile station 3 to a relay station 1 based on a signal received from the mobile station 3. An MCS predictor 20 predicts, from channel quality, which one of MCSs is to be used. An MCS extractor 16 extracts an MCS indicated to the mobile station 3 by a base station 4. The extracted MCS of the channel from the mobile station 3 to the base station 4 is input to an MCS comparator 18. The MCS comparator 18 compares the level of the predicted MCS of the channel from the mobile station 3 to the relay station 1 with the level of the indicated MCS of the channel from the mobile station 3 to the base station 4. When the levels are close to each other, the next signal is determined to be relayed by way of the relay station 1. When the level of the MCS of the channel from the mobile station 3 to the relay station 1 is lower (lower in terms of the degree of multiplicity) than the level of the MCS of the channel from the mobile station 3 to the relay station 1 by a given amount or more, the next signal is determined to be a direct communication.

### TECHNICAL FIELD

The present invention relates to a radio communication method and a radio communication apparatus; more particularly, enhancement of a throughput characteristics and a degree of multiplicity of an MCS.

### BACKGROUND ART

In recent years, a technical approach for implementing a high transmission rate in a cellular mobile communication system typified by a portable mobile phone by utilization of a high frequency radio band has been studied actively. As compared with a case where a low frequency radio band is utilized, attenuation attributable to a transmission distance becomes greater when a high frequency radio band is utilized. Therefore, an area where implementation of a high transmission rate can be expected is limited to a comparatively-short-range area.

For this reason, there arises a necessity for installing a larger number of base station units within a system. Since installation of the base station units involve consumption of commensurate cost, there is a strong demand for implementing a high transmission rate while an increase in the number of base station units to be installed is cut.

A technique employing a relay is available as a technique for meeting the demand. So long as a relay is used, even a mobile station incapable of transmitting a direct communication to the base station unit can handle a communication by way of a relay station unit. A relay station unit that directly assists a communication by use of the relay technique has also been put forward (see; for instance, Patent Document 1).

Patent Document 1: JP-A-2004-15136

### DISCLOSURE OF THE INVENTION

### Problem that the Invention is to Solve

According to a technique described in connection with Patent Document 1, a signal transmitted by a transmission terminal toward a receiving terminal is also received by an auxiliary terminal (a relay station). When failed to receive data, the receiving terminal transmits a relay request to the auxiliary terminal. The auxiliary terminal which has received the relay request relays a signal received from the transmission terminal to the receiving terminal. Since the auxiliary terminal relays the signal that the receiving terminal could not have received, the technique described in connection with Patent Document 1 yields an advantage of a decrease in the number of transmission operations to be performed by the transmission terminal.

However, according to the related-art technique described in connection with Patent Document 1, an attempt is first sending a direct communication even when the quality of a channel from the transmission terminal to the receiving terminal is poor, an MCS (Modulation and Coding Scheme) rate to be set is decreased, which in turn raises a problem of deterioration of a throughput. Further, since the auxiliary terminal performs relaying after received a relay request, there arises a problem of a decrease in throughput characteristic induced by a time for waiting the request.

The present invention has been conceived in light of the circumstance of the related art and aims at providing a radio communication method and a radio communication apparatus that allow enhancement of a throughput characteristic and a degree of multiplicity of an MCS without a necessity for a special additional function for a mobile object.

### Means for Solving the Problem

According to the invention, there is provided a radio communication system in which a relay station relays a signal between a mobile station and a base station, wherein the relay station includes: a unit for determining quality of an uplink from the mobile station to the base station; a unit for generating an uplink relay signal based on the signal received from the mobile station when the quality of the uplink is determined to be poor; and a unit for transmitting the generated uplink relay signal to the base station, and wherein the base station includes a unit for indicating to the mobile station an MCS in which a degree of multiplicity appropriate for a communication with the relay station is set when the quality of the uplink is determined to be poor.

According to the configuration, when receiving quality achieved by the mobile station is poor, the relay station automatically transmits a relay signal. Hence, transmission of a relay request is omitted, whereby a throughput characteristic is enhanced. According to the configuration, an MCS for a direct link (a direct communication between the mobile station and the base station) and an MCS for a link established by way of a relay station can be switched without adding a function to the mobile station.

A radio communication apparatus according to the invention serves as the relay station making up the radio communication system according to the invention.

The radio communication apparatus according to the invention includes: a channel quality measurement section that measures, based on the signal received from the mobile station, channel quality from the mobile station to the radio communication apparatus; an MCS predictor that predicts, based on the channel quality measured by the channel quality measurement section, an MCS to be used for a communication from the mobile station to the radio communication apparatus; an MCS extractor that extracts, from the signal received from the base station, an MCS indicated to the mobile station by the base station; and an MCS comparator that compares a level of the MCS predicted by the MCS predictor with a level of the MCS extracted by the MCS extractor, and that determines the quality of the uplink to be poor when the two MCS levels are in close proximity to each other.

According to the configuration, a comparison can be performed by use of the MCS levels; hence, there is obviated a necessity for indicating information about quality of a channel from the mobile station to the base station.

The radio communication apparatus according to the invention does not transmit the uplink relay signal until receiving a relay request from the mobile station when channel quality from the mobile station to the base station is determined to be high.

According to the configuration, relaying operation, which would otherwise be performed in spite of the fact that sufficient receiving quality is achieved by the mobile station, can be prevented.

A radio communication apparatus according to the invention serves as the base station making up the radio communication system according to the invention.

The radio communication apparatus according to the invention includes a unit for indicating an MCS to the mobile station from the mobile station to the relay station when the quality of the uplink is determined to be poor.

According to the configuration, when an MCS of a channel from the mobile station to the relay station is set, the possibility of occurrence of a receiving failure in the relay station can be reduced.

The radio communication apparatus according to the invention includes: a channel quality measurement section that has a function of measuring, based on a signal received from the mobile station, channel quality from the mobile station to the radio communication apparatus and a function of measuring, based on a signal received from the relay station, channel quality from the relay station to the radio communication apparatus; a channel quality information extractor that extracts, from the signal received from the relay station, channel quality from the mobile station to the relay station; and an MCS indication signal generator that determines an MCS to be indicated to the mobile station, based on the channel quality for a communication from the mobile station to the radio communication apparatus and the channel quality for a communication from the relay station to the radio communication apparatus, which are measured by the channel quality measurement section, and also based on the channel quality for a communication from the mobile station to the relay station extracted by the channel quality information extractor.

According to the invention, there is provided a radio communication system in which a relay station relays a signal between a mobile station and a base station, wherein the relay station includes: a unit for determining quality of a downlink from the base station to the mobile station; a unit for generating a downlink relay signal based on the signal received from the base station when the quality of the downlink is determined to be poor; and a unit for transmitting the generated downlink relay signal to the mobile station; and wherein the base station includes a unit for indicating to the mobile station an MCS having a modified degree of multiplicity when the quality of the downlink is determined to be poor.

According to the configuration, when receiving quality achieved by the mobile station is poor, the relay station automatically transmits a relay signal. Hence, transmission of a relay request is omitted, whereby a throughput characteristic is enhanced.

A radio communication apparatus according to the invention serves as the relay station making up the radio communication system according to the invention.

The radio communication apparatus according to the invention includes: a channel quality information generator that measures, based on the signal received from the base station, channel quality from the base station to the radio communication apparatus, to thus generate channel quality information to be indicated to the base station; an MCS acquirer that acquires an MCS of the signal received from the base station; a channel quality information extractor that extracts channel quality information showing channel quality from the base station to the mobile station transmitted from the mobile station, and channel quality information showing channel quality from the radio communication apparatus to the mobile station; an MCS predictor that predicts a level of an MCS based on the channel quality information from the base station to the mobile station extracted by the channel quality information extractor; and an MCS comparator that compares a level of the MCS predicted by the MCS predictor with the level of the MCS acquired by the MCS section, and that determines the quality of the downlink to be poor when the MCS level predicted by the MCS predictor is higher than the MCS level acquired by the MCS acquirer by a given amount or more.

According to the configuration, a determination can be made as to whether or not receiving quality achieved by the mobile station is sufficient, by use of the MCS.

The radio communication apparatus according to the invention includes a transmission amount determiner that determines an amount of transmission of the downlink relay signal based on channel quality from the base station to the mobile station, channel quality from the radio communication apparatus to the mobile station, and the MCS acquired by the MCS acquirer.

According to the configuration, receiving quality is predicted from channel quality and an MCS, and relaying operation can be performed to a required extent, so that a throughput characteristic is enhanced.

A radio communication method for relaying a signal between a mobile station and a base station by a relay station according to the invention includes the steps of: determining by the relay station, channel quality from the mobile station to the base station; and generating a relay signal based on a signal received from the mobile station and transmitting the relay signal to the base station when the channel quality is determined to be poor.

The radio communication method according to the invention includes the steps of: comparing by the relay station, an MCS assigned to a communication from the mobile station to the base station with an MCS predicted based on channel quality from the mobile station to the relay station; and

determining the channel quality from the mobile station to the base station to be poor when a level of the MCS assigned to the communication from the mobile station to the base station and a level of the MCS predicted based on the channel quality from the mobile station to the relay station are in close proximity to each other.

In the radio communication method according the invention, the relay station does not perform relaying operation until a relay request is issued by the mobile station when the channel quality from the mobile station to the base station is determined to be high.

In the radio communication method according to the invention, when determined that the channel quality from the mobile station to the base station is poor, the base station notifies the mobile station of an MCS having a modified degree of multiplicity.

In the radio communication method according to the invention, the MCS having the modified degree of multiplicity that is to be indicated to the mobile station is an MCS of the communication from the mobile station to the relay station.

A radio communication method for relaying a signal between a base station and a mobile station by a relay station according to the invention includes the steps of: determining by the relay station, channel quality from the base station to the mobile station; and generating a relay signal based on a signal received from the base station and transmitting the relay signal to the mobile station when the channel quality is determined to be poor.

The radio communication method according to the invention includes the steps of: comparing by the relay station, an MCS of a signal transmitted from the base station with an MCS predicted from channel quality from the base station to the mobile station; and determining the channel quality from the base station to the mobile station to be poor when a difference between a level of the MCS of the signal transmitted from the base station and a level of the MCS predicted based on the channel quality from the base station to the mobile station is a given amount or more and when the MCS level of the signal transmitted by the base station is low.

The radio communication method according to the invention includes the steps of: receiving by the relay station, channel quality indicated to the base station by the mobile station; predicting receiving quality achieved by the mobile station based on the received channel quality and an MCS of a signal transmitted by the base station to the mobile station; and determining an amount of transmission of a relay signal so as to fulfill desired receiving quality of the mobile station.

According to the invention, there is provided a radio communication apparatus that serves as a relay station for relaying a communication between a mobile station and a base station, the apparatus including: an acquisition unit that acquires quality of the communication between the mobile station and the relay station; a selection unit that selects a first parameter corresponding to the acquired communication quality; a receiving unit that receives information including a second parameter designated by the base station so as to be used in a transmission from the mobile station; a determination unit that determines whether or not a value of the second parameter is close to a value of the first parameter; and a transmission unit that relays the signal transmitted from the mobile station to the base station when the determination is affirmative.

In the radio communication apparatus according to the invention, the transmission unit inhibits a relay transmission to the base station until a relay request is received from the base station when the determination is negative.

In the radio communication apparatus according to the invention, the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code.

According to the invention, there is provided a radio communication apparatus that serves as a relay station for relaying a communication between a base station and a mobile station, the apparatus including: a receiving unit that receives from the mobile station information about quality of a communication between the base station and the mobile station and that further receives from the base station information about a second parameter used in a transmission from the base station; a selection unit that selects a first parameter corresponding to the communication quality; a determination unit that determines whether or not a value of the second parameter is to be used in a communication channel that is higher in quality than a communication channel in which a value of the first parameter or a value near the value of the first parameter is used; and a transmission unit that relays the signal transmitted by the base station to the mobile station when the determination is affirmative.

In the radio communication apparatus according to the invention, the transmission unit inhibits a relay transmission to the mobile station until a relay request is received from the mobile station when the determination is negative.

In the radio communication apparatus according to the invention, the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code.

According to the invention, there is provided a radio communication apparatus that serves as a relay station for relaying a communication between a base station and a mobile station, the apparatus including: an acquisition unit that acquires quality of the communication between the base station and the relay station; a selection unit that selects a first parameter corresponding to the acquired communication quality; a receiving unit that receives, from the base station, information about a second parameter used in a transmission originated from the base station; a determination unit that determines whether or not a value of the second parameter is close to a value of the first parameter; and a transmission unit that relays the signal transmitted from the base station to the mobile station when the determination is affirmative.

In the radio communication apparatus according to the invention, the transmission unit inhibits a relay transmission to the mobile station until a relay request is received from the mobile station when the determination is negative.

In the radio communication apparatus according to the invention, the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code.

### ADVANTAGE OF THE INVENTION

According to a radio communication method and a radio communication apparatus of the present invention, when channel quality from a mobile station to a base station is poor, a relay station can perform relaying operation without waiting for a relay request by prediction of a necessity for a relay, so that a throughput characteristic can be enhanced.

### BRIEF DESCRIPTION OF THE DRAWINGS

FIG. 1 is a system configuration view of a radio communication method of a first embodiment of the present invention.

FIG. 2 is a sequence diagram of the radio communication method of the first embodiment of the present invention.

FIG. 3 is a block diagram of a relay station of the first embodiment of the present invention.

FIG. 4 is a flowchart of the relay station of the first embodiment of the present invention.

FIG. 5 is a block diagram of a base station of the first embodiment of the present invention.

FIG. 6 is a system configuration view of a radio communication method of a second embodiment of the present invention.

FIG. 7 is a sequence diagram of the radio communication method of the second embodiment of the present invention.

FIG. 8 is a block diagram of a relay station of the second embodiment of the present invention.

FIG. 9 is a descriptive view of a manner to determine an SNR required by a relay.

FIG. 10 is a flowchart of the relay station of the second embodiment of the present invention.

FIG. 11 is a block diagram of the base station of the second embodiment of the present invention.

### DESCRIPTIONS OF THE REFERENCE NUMERALS AND SYMBOLS

1 RELAY STATION
3 MOBILE STATION
4 BASE STATION
11 BUFFER
12, 51 ENCODER
13, 52 MODULATOR
14, 53 RADIO TRANSMITTER
15, 24, 54, 63 ANTENNA
16 MCS EXTRACTOR
17, 59 DECODER
18 MCS COMPARATOR
19, 60 DEMODULATOR
20, 31 MCS PREDICTOR
21, 61 CHANNEL QUALITY MEASUREMENT SECTION
22 RELAY REQUEST RECEIVER
23, 62 RADIO RECEIVER
32, 57 CHANNEL QUALITY INFORMATION EXTRACTOR
33 MCS ACQUIRER
35 CHANNEL QUALITY INFORMATION GENERATOR
55 RELAY REQUEST GENERATOR
56 ERROR DETECTOR
58 MCS NOTICE SIGNAL GENERATOR
71 MCS DETERMINER

### BEST MODES FOR IMPLEMENTING THE INVENTION

Embodiments of the present invention will be hereinbelow described by reference to the drawings.

### Embodiment 1

### Uplink Relay

The present embodiment describes an example uplink of a communication system made up of a mobile station, a relay station, and a base station, wherein, when a signal is transmitted from the mobile station to the base station, the relay station relays the signal transmitted from the mobile station to the base station, as required. In the present embodiment, the relay station receives a signal transmitted from the mobile station toward the base station and determines whether or not quality with which the base station receives the signal transmitted from the mobile station toward the base station is sufficient. When determined that receiving quality is poor, the relay station transmits (relays) a relay signal (an uplink relay signal) without waiting for a relay request. When determined that receiving quality is high, the relay station does not perform relaying operation until a relay request is sent from the base station.

When the quality of a channel from the mobile station to the base station is poor, the base station notifies the mobile station of an MCS (Modulation and Coding Scheme) appropriate for the channel quality from the mobile station to the relay station. Even when there is an MCS intended for the relay station, the mobile station can perform transmission by means of the indicated MCS without realizing the MCS for the relay station because the mobile station performs transmission by means of the indicated MCS at this time.

By means of these operations, when the channel quality from the mobile station to the base station is poor, the relay station can perform relay operation without waiting for a relay request by prediction of a necessity for a relay; hence, a throughput characteristic can be enhanced.

When channel quality is poor, the base station sets an MCS by prediction of a transmission by way of the relay station, and therefore a degree of multiplicity of the MCS can be increased. Further, since the mobile station only sends a transmission by means of the MCS specified by the base station, a special additional function is not required.

[System Configuration]

The embodiment of the present invention will be described in detail by reference to the drawings. A radio communication apparatus, which will be described below, is a radio communication apparatus that relays a transmission signal from a first radio communication apparatus to a second radio communication apparatus and that is to be incorporated in; for instance, a relay station used for a mobile communication system. In the following embodiment, descriptions are provided on the assumption that a radio communication apparatus that performs relay transmission is a relay station; that the first radio communication apparatus is a mobile station; and that the second radio communication apparatus is a base station.

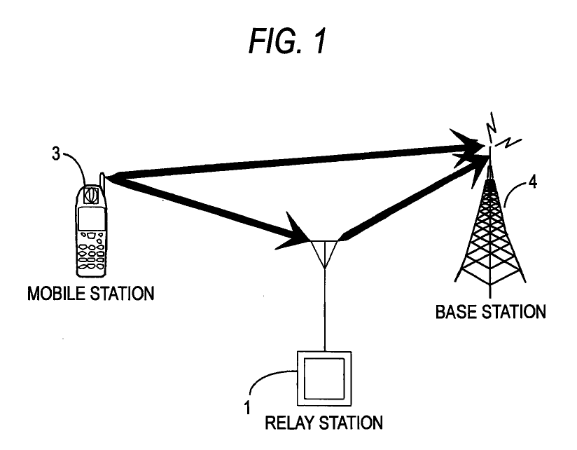

The mobile communication system shown in FIG. 1 includes a relay station 1, a mobile station 3, and a base station 4. In the mobile communication system, a signal transmitted by the mobile station 3 is received by the base station 4 and the relay station 1, as shown in FIG. 1. When determined that receiving quality achieved by the base station 4 is poor, the relay station 1 relays the received signal to the base station 4 without waiting for a relay request. The base station 4 generates received signal by combination of the signal received from the mobile station 3 with the signal received from the relay station 1.

[Sequence Diagram]

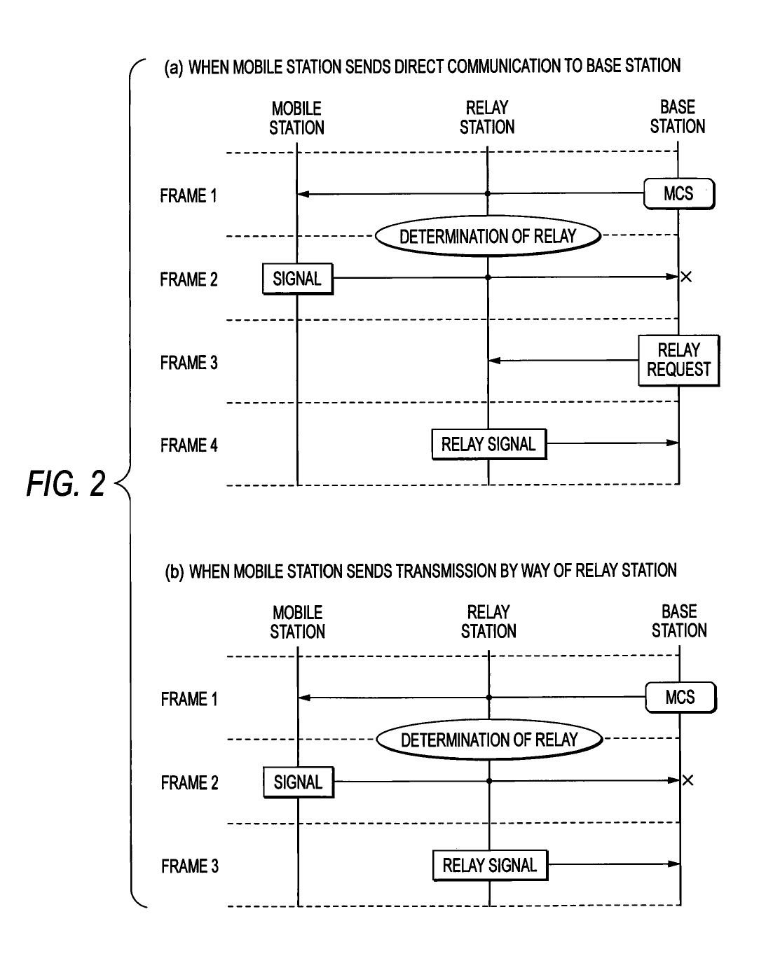

Overall processing is described by reference to a sequence diagram shown in FIG. 2. In FIG. 2, (a) shows a sequence achieved when the mobile station 3 directly sends a transmission to the base station 4, and (b) shows a sequence achieved when the mobile station 3 sends a transmission by way of the relay station 1.

The base station 4 keeps the ascertainment of quality of a channel from the mobile station 3 to the base station 4, quality of a channel from the relay station 1 to the base station 4, and quality of a channel from the mobile station 3 to the relay station 1. The base station 4 determines the channel quality from the mobile station 3 to the base station 4 and the channel quality from the relay station 1 to the base station 4 by measuring the signal transmitted to the base station 4. The base station 4 ascertains the channel quality from the mobile station 3 to the relay station 1 upon receipt of a report from the relay station 1.

The base station 4 determines, by use of the quality of the three channels, whether the mobile station 3 sends a transmission directly to the base station 4 or by way of the relay station 1. When determined that it is better to send the transmission directly to the base station 4 from the mobile station 3, the base station 4 notifies, by means of a frame 1, the mobile station 3 of an MCS intended for the base station 4, as shown in (a) of FIG. 2.

The relay station 1 also receives the indicated MCS at this time, thereby ascertaining the MCS by means of which the mobile station 3 sends the transmission. The relay station 1 compares the MCS indicated to the mobile station 3 by the base station 4 with an MCS (a predicted MCS) predicted from the channel quality from the mobile station 3 to the relay station 1. The MCS predicted from the channel quality from the mobile station 3 to the relay station 1 (i.e., the predicted MCS) is a parameter (a first parameter) corresponding to the channel quality from the mobile station 3 to the relay station 1. The MCS indicated to the mobile station 3 by the base station 4 is a parameter (a second parameter) that is designated by the base station 4 to be used in a transmission from the mobile station 3.

If the two MCS levels are in close proximity to each other, the relay station 1 determines that the next signal is transmitted by way of the relay station 1. Further, when the MCS indicated to the mobile station 3 by the base station 4 is lower than the MCS predicted by a given level or more with regard to the channel from the mobile station 3 to the relay station 1 in terms of a degree of multiplicity, the relay station 1 determines that the next signal is to be transmitted directly to the base station 4.

In (a) of FIG. 2, the relay station 1 determines in a frame 1 by use of the determination method, that a communication of the next signal is sent directly to the base station 4. Subsequently, the mobile station 3 sends a signal to the base station 4 in a frame 2. The base station 4 and the relay station 1 receive the signal from the mobile station 3.

The base station 4 determines whether or not the received signal includes an error. If there is an error, the base station 4 transmits a relay request to the relay station 1 by means of a frame 3. Upon receipt of the relay request, the relay station 1 generates a relay signal from the stored, received signal and sends the signal to the base station 4 by means of a frame 4. In FIG. 2, (a) shows an example in which the base station 4 determines an error in the signal. However, when the signal can have been correctly received, communication ends.

There is provided a case where the channel quality from the mobile station 3 to the base station 4 is poor and where the base station 4 determines that transmitting a signal by way of the relay station 1 is better. As shown in (b) of FIG. 2, when determined that a communication is sent by way of the relay station 1, the base station 4 notifies the mobile station 3 of the MCS intended for the relay station 1 by means of the frame 1. As in the case shown in (b) of FIG. 2, the relay station 1 also receives the thus-indicated MCS at this time, thereby ascertaining the MCS by means of which the mobile station 3 sends a transmission.

In (b) of FIG. 2, in the frame 1 the MCS indicated to the mobile station 3 is compared with the MCS predicted based on the channel quality from the mobile station 3 to the base station 4. When the two MCS levels are in close proximity to each other, the relay station 1 determines that the next signal is transmitted by way of the relay station 1 (a relay determination), thereby determining transmission of a relay signal.

Subsequently, the mobile station 3 sends a signal toward the base station 4 in the frame 2. The base station 4 and the relay station 1 receive the signal from the mobile station 3. The relay station 1 determines, in the frame 1 from the MCS, that the next signal is transmitted by way of the relay station 1 and determines transmission of the relay signal. Hence, the relay station generates the relay signal in the frame 3 and transmits the thus-generated relay signal to the base station 4.

[Relay Station Block Diagram]

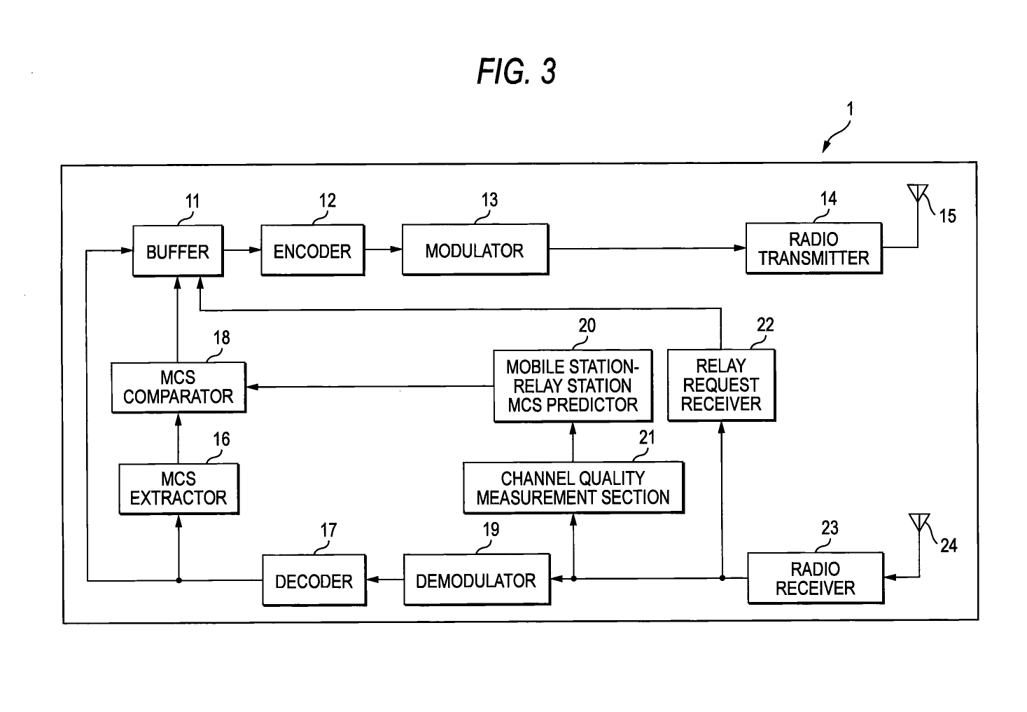

FIG. 3 is a block diagram showing the configuration of the relay station 1 of the embodiment. In the relay station 1, a radio receiver 23 receives a signal from the mobile station 3 or the base station 4 by way of an antenna 24 and subjects the thus-received signal to radio processing, such as downconversion, and outputs a resultant signal. The signal output from the radio receiver 24 is demodulated by a demodulator 19 and decoded by a decoder 17. The signal output from the radio receiver 24 is also input to a channel quality measurement section 21 and a relay request receiver 22 which will be described later. The signal decoded by the decoder 17 is stored in a buffer section 11. The signal decoded by the decoder 17 is input to an MCS extractor 16 to be described later.

The channel quality measurement section 21 measures, on the basis of the signal received from the mobile station 3, the channel quality from the mobile station 3 to the relay station 1. The measured channel quality is input to a mobile station-relay station MCS predictor 20. The mobile station-relay station MCS predictor 20 predicts, based on the measured channel quality from the mobile station to the relay station, which one of MCSs is used in the case of performance of a relay.

Of pieces of information about the MCS predicted by the mobile station-relay station MCS predictor 20, information analogous to the information stored in the base station 4 is input to an MCS comparator 18. The MCS extractor 16 extracts the MCS indicated to the mobile station 3 by the base station 4 from the signal decoded by the decoder 17. The MCS extracted by the MCS extractor 16 with regard to the channel from the mobile station 3 to the base station 4 is input to the MCS comparator 18.

The MCS comparator 18 compares a level of the MCS predicted by the mobile station-relay station MCS predictor 20 with regard to the channel from the mobile station 3 to the relay station 1 with a level of the MCS extracted by the MCS extractor 16 and indicated by the base station 4 with regard the channel from the mobile station 3 to the base station 4. When the two MCS levels are in close proximity to each other, the MCS comparator 18 determines that the next signal is transmitted by way of the relay station 1. In contrast, when the level of the MCS with regard to the channel from the mobile station 3 to the relay station 1 is lower (lower in terms of the degree of multiplicity) than the level of the MCS with regard to the channel from the mobile station 3 to the base station 4 by a given value or more, the MCS comparator 18 determines that the next signal is a direct communication. When determined that the next signal is transmitted by way of the relay station 1, the MCS comparator 18 commands the buffer section 11 to transmit a relay signal. When the MCS comparator 18 determines that the next signal is a direct communication, the relay station 1 performs nothing in the next frame.

Upon receipt of the relay request signal from the base station 4, the relay request receiver 22 commands the buffer 11 to transmit a relay signal. The relay signal output from the buffer section 11 is encoded by the encoder 12, and the thus-encoded signal is input to the modulator 13. The relay signal modulated by the modulator 13 is input to a radio transmitter 14. The radio transmitter 14 subjects the thus-input relay signal to radio processing, such as upconversion, and transmits the relay signal from the antenna 15.

Operation of the MCS comparator 18 is described by reference to an example. MCS levels are assumed to be set as shown in Table 1, and the base station 4 and the relay station 1 hold the table.

TABLE 1
MCS Level

| SNR[dB] | MCS Level | MCS |
|---|---|---|
| ~2 | 1 | BPSK ½ |
| 2~5 | 2 | QPSK ⅓ |
| 5~9 | 3 | QPSK ½ |
| 9~13 | 4 | QPSK ¾ |
| 13~16 | 5 | 16QAM ⅔ |
| 16~18 | 6 | 16QAM ¾ |
| 18~22 | 7 | 16QAM ⅚ |
| 22~ | 8 | 64QAM ⅔ |

The relay station 1 compares the level of the MCS indicated to the mobile station 3 by the base station 4 with the level of the MCS achieved in the channel from the mobile station 3 to the relay station 1. When a difference between the levels falls within a range of ±1, the levels are determined to be values that are in close proximity to each other, and a relay signal is transmitted without awaiting a relay request.

The relay station 1 acquires an SNR value from the signal transmitted from the mobile station 3 by means of the channel quality measurement section 21. The mobile station-relay station MCS predictor 20 predicts an MCS from the SNR value by use of the table. At this time, when SNR=6 [dB] is acquired, the MCS level is determined to be three from Table 1. The MCS with a level 3 is QPSK 1/2 and hence a prediction MCS is set to QPSK 1/2.

By means of the MCS extractor 16, the relay station 1 acquires the MCS indicated to the mobile station 3 by the base station 4. When the indicated MCS is QPSK 1/3, the MCS level is two according to Table 1. Since the predicted MCS level is three and since the indicated MCS level is two, the relay station 1 determines that the two MCS levels fall within a predetermined range; namely, that the mobile station 3 sends a transmission by way of the relay station 1, and determines that a transmission is sent without awaiting a relay request.

When the indicated MCS level is four or more, the relay station 1 determines that the mobile station 3 is sending a transmission directly to the base station 4 and does not transmit the relay signal until a relay request is issued.

[Relay Station Flowchart]

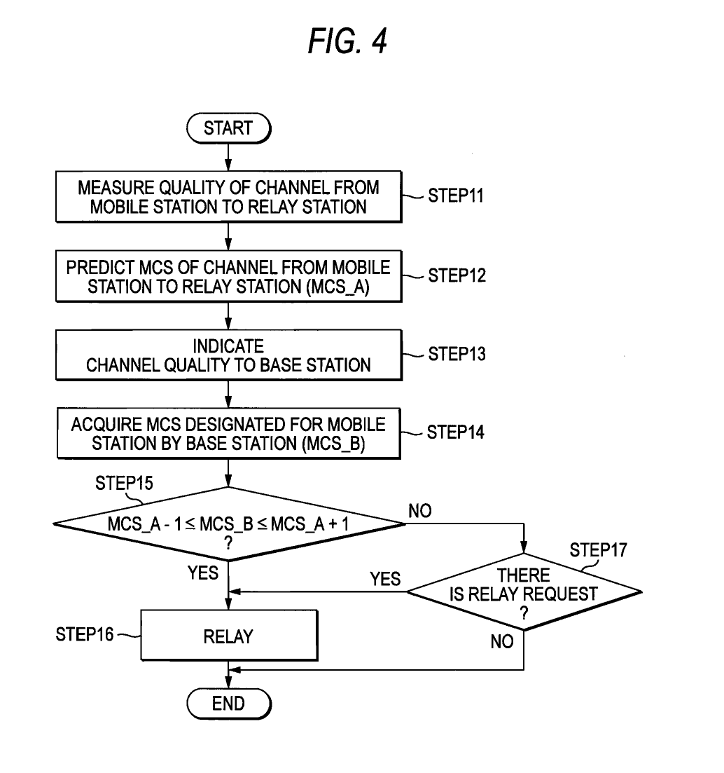

FIG. 4 is a flowchart showing processing procedures of the relay station of the present embodiment.

In step 11, by means of the channel quality measurement section 21, the relay station 1 measures the channel quality from the mobile station 3 to the relay station 1 through use of the signal transmitted by the mobile station 3. In step 12, the relay station 1 predicts an MCS with regard to the channel from the mobile station 3 to the relay station 1 based on the channel quality measured in step 11, by means of the mobile station-relay station MCS predictor 2. The table of MCS levels shown in Table 1 is used for prediction. A predicted MCS is taken as MCS_A. In step 13, the relay station 1 notifies the base station 4 of the channel quality from the mobile station 3 to the relay station 1 measured in step 11.

Next, in step 14, the relay station 1 receives the signal transmitted by the base station 4 to the mobile station 3 and acquires a designated MCS from a control signal. The thus-acquired MCS is taken as MCS_B. In step 15, the relay station 1 compares the MCS_A level with the MCS_B level by means of the MCS comparator 18. The relay station 1 determines that a relay is necessary when the MCS_B level falls within a range of MCS_A±1, and proceeds to step 16. When the MCS_B level is outside the range, the relay station proceeds to step 17. In step 16, the relay station 1 relays the signal received from the base station 4 to the mobile station 3. In step 17, the relay station 1 determines whether or not there is a relay request from the mobile station 3. The relay station 1 proceeds to step 16 when there is a relay request but proceeds to an end when there is no relay request.

The report about channel quality made in step 13 does not need to be made every time. For instance, a report may also be made only when a change has arisen in channel quality.

[Base Station Block Diagram]

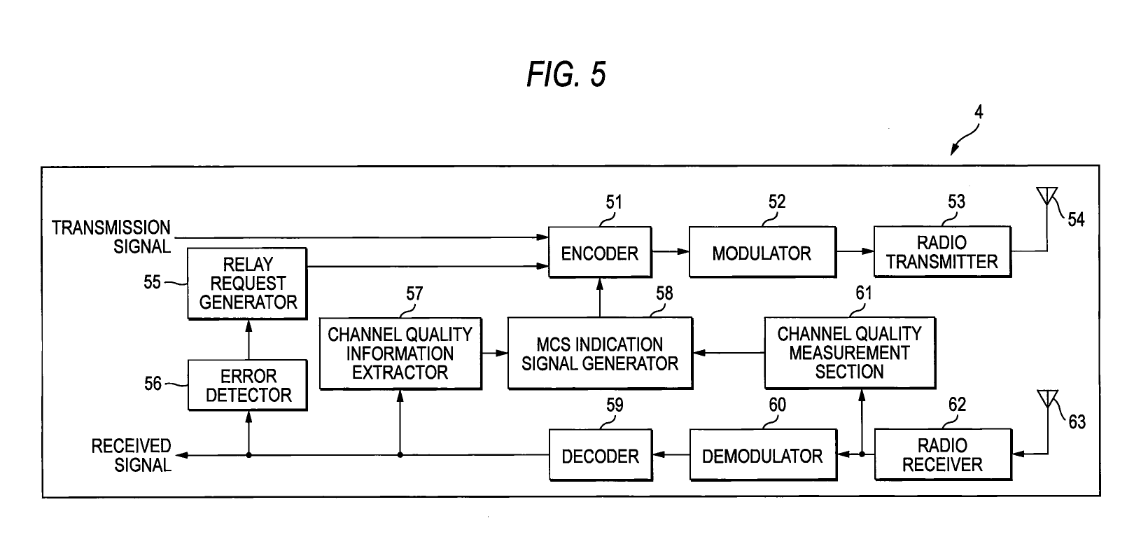

FIG. 5 is a block diagram showing the configuration of the base station 4 of the embodiment. Explanations of blocks that are functionally equal to the relay station 1 shown in FIG. 3 are omitted. A channel quality measurement section 61 measures, based on a signal received from the mobile station 3, the quality of a channel from the mobile station 3 to the base station 4; and measures, based on a signal received from the relay station 1, the quality of a channel from the relay station 1 to the base station 4. The channel quality measurement section 61 inputs measurement results to an MCS indication signal generator 58.

A channel quality information extractor 57 extracts, from a signal decoded by the decoder 59 (the signal received from the relay station 1), information about the channel quality of a communication from the mobile station 3 to the relay station 1 reported by the relay station 1. Channel quality information extracted by the channel quality information extractor 57 is input to the MCS indication signal generator 58. The MCS indication signal generator 58 determines which one of the MCSs is indicated to the mobile station 3, from the channel quality from the mobile station 3 to the base station 4, the channel quality from the relay station 1 to the base station 4, and the channel quality from the mobile station 3 to the relay station 1.

The base station 4 holds the same table as that held by the relay station 1. When the MCS indication signal generator 58 of the base station 4 desires to send a communication directly to the mobile station 3 in accordance with the table, the MCS indicated to the mobile station 3 is set to an MCS that differs from the MCS predicted with regard to the channel between the mobile station 3 and the relay station 1 by two levels or more. When a transmission is desired to be made by way of the relay station 1, there is generated an MCS notification signal that sets an MCS differs from the MCS predicted with regard to the channel between the mobile station 3 and the relay station 1 by one level or less. The MCS indication signal generator 58 inputs to an encoder 51 an MCS notification signal for indicating a determined MCS.

Meanwhile, the error detector 56 determines, by means of a CRC, whether or not the received signal (the signal decoded by the decoder 59) includes an error. When the error is included, the error detector 56 notifies a relay request generator 55 of the error. The relay request generator 55 generates a relay request signal and input the signal to the encoder 51.

As mentioned above, in the present embodiment, when the channel quality from the mobile station 3 to the base station 4 is poor, a necessity for a relay is predicted, and a relay signal can be transmitted from the relay station 1 without awaiting a relay request. Therefore, a throughput characteristic can be enhanced.

When channel quality is poor, an MCS transmitted by the mobile station 3 can be set on the assumption that the signal is sent by way of the relay station 1. Hence, the degree of multiplicity of the MCS can be increased. Further, since all the mobile station 3 has to do is to send the signal by means of the MCS designated by the base station 4, switching between a direct communication and a communication performed by way of the relay station 1 can be performed without involvement of a necessity for a special additional function.

The base station 4 may also indicate the mobile station 3 in charge to the relay station 1 before commencement of communication. Alternatively, the relay station 1 may also be indicated that the relay station is released from the charge when the channel quality from the mobile station 3 to the base station 4 has increased by a given level or more.

The relay station 1 may also indicate to the base station 4 the quality of communication from the mobile station 3 to the relay station 1, at a predetermined frequency or only when a change has arisen.

A level difference determined by the relay station 1 is described as ±1 in the present embodiment but may also be described as zero. Moreover, a range, such as a range from −1 to 2, may also be set for the level difference. The range of a level difference may also be indicated to the relay station by the base station before commencement of a communication or may previously be set by a system.

In the embodiment, a determination is made on the basis of whether or not the level difference falls within a range; however, a determination may also be made on the basis of the magnitude of a level difference.

An MCS level, a CQI, a SNR, a SIR, a SINR, a CIR, a CNR, a CINR, an RSSI, received power, interference power, an error rate, a transmission rate, a throughput, a prediction error rate, traveling speed of a moving station, intensity of channel fluctuation, the type of an error correction code, and the like, may also be used for channel quality.

The mobile station 3 is arranged so as to be able to separately set transmission power for a pilot portion for estimating channel quality and transmission power for a data portion. The power for the pilot portion may also be set to a value at which the signal arrives at the base station 4.

### Embodiment 2

### Downlink Relay

In the present embodiment, there is described an example downlink in which the relay station relays, as required, a signal transmitted from the base station to the mobile station in contrast with the embodiment 1 (an uplink relay), in connection with a communication system made up of the mobile station, the relay station, and the base station as in the embodiment 1. In the present embodiment, the relay station compares the MCS determined based on the channel quality from the base station to the mobile station with the MCS of a received signal, thereby determining whether or not the base station has sent a communication directly or by way of the relay station (i.e., the quality of a down link is low). When determined that the communication has been sent by way of the relay station, the relay station transmits a relay signal (a downlink relay signal) to the moving station without awaiting a relay request.

In the present embodiment, when transmitting a relay signal to the mobile station, the relay station predicts the amount of relay signal required by the mobile station and transmits the relay signal so as to fulfill the predicted amount of relay signal. In order to predict the amount of relay signal, the relay station acquires information about the quality of a channel from the base station to the mobile station and the channel quality from the relay station to the mobile station, which are reported to the base station by the mobile station, and the amount of signal transmitted from the base station to the mobile station.

As configured above, the relay station determines whether or not receiving quality required by the mobile station is fulfilled and can transmit a relay signal. Since the required amount of relay signal can be computed, a required amount of signal can be relayed. Hence, a throughput characteristic is enhanced.

[System Configuration]

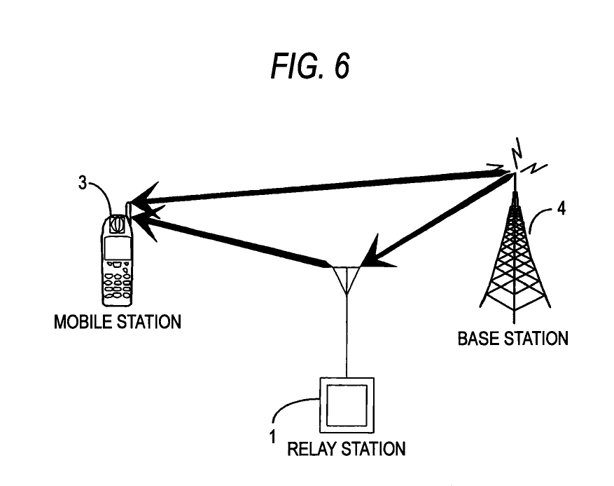

As in the case of FIG. 1, the mobile communication system shown in FIG. 6 includes the relay station 1, the mobile station 3, and the base station 4. As shown in FIG. 6, the signal transmitted from the base station 4 is received by the mobile station 3 and the relay station 1 in the mobile communication system. When determined that the signal received by the mobile station 3 is insufficient, the relay station 1 relays the received signal to the mobile station 3. The mobile station 3 combines a signal received from the base station 4 with a signal received from the relay station 1, to thus generate a received signal. In the present embodiment, a communication is established not directly but by way of the relay station 1 in connection with the uplink (a channel from the mobile station 3 to the base station 4).

[Sequence Diagram]

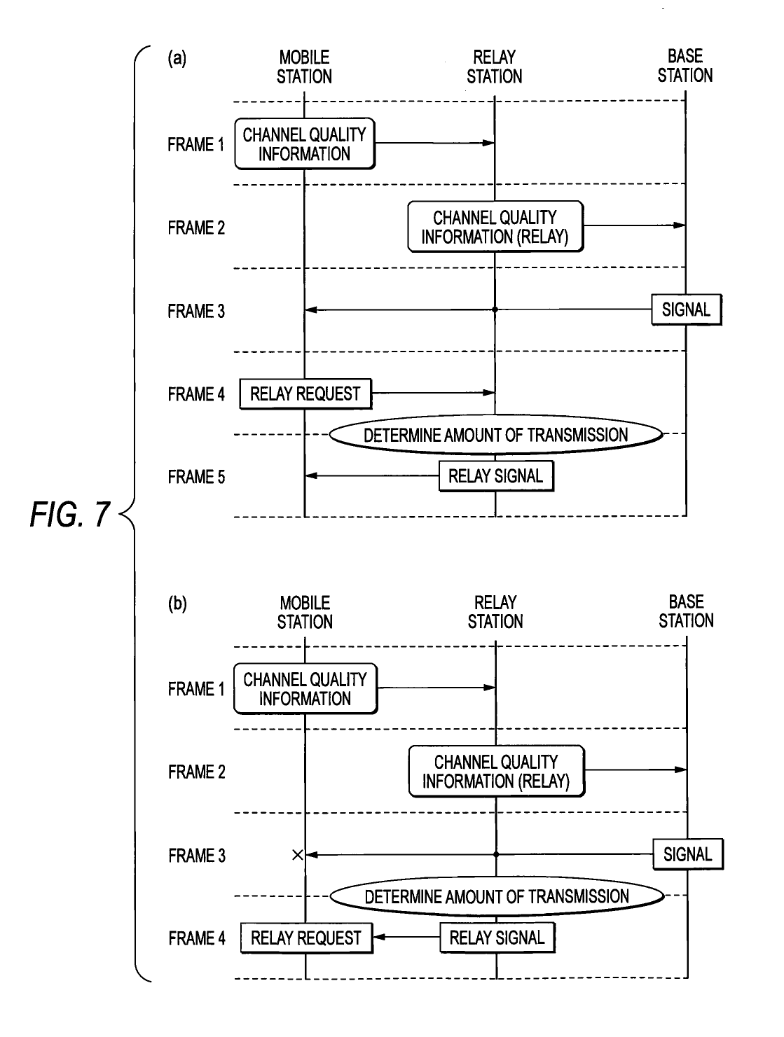

Overall processing of the present embodiment is now described by use of a sequence diagram shown in FIG. 7. In FIG. 7, (a) shows a sequence achieved when the base station 4 establishes a communication directly with the mobile station 3, and (b) shows a sequence achieved when the base station 4 sends a transmission by way of the relay station 1.

Prior to the illustrated frames (the frame 1 through the frame 5), the mobile station 3 receives the signal from the base station 4 and the signal from the relay station 1, thereby generating information about the channel quality from the base station 4 to the mobile station 3 and information about the channel quality from the relay station 1 to the mobile station 3. Channel quality information is transmitted to the relay station 1 by means of the frame 1. By means of the frame 2, the relay station 1 transmits to the base station 4 the received channel quality information and the information about the channel quality from the base station 4 to the relay station 1.

By use of the quality of the three channels; namely, the channel from the base station 4 to the mobile station 3, the channel from the base station 4 to the relay station 1, and the channel from the relay station 1 to the mobile station 3, the base station 4 determines whether the base station 4 sends a signal directly to the mobile station 3 or by way of the relay station 1. The base station 4 determines an MCS from the channel quality information and transmits the signal by means of a frame 3.

The relay station 1 receives the signal transmitted from the base station 4 by means of the frame 3 and acquires an MCS from a control signal portion of the received signal. The relay station 1 compares the acquired MCS with the MCS predicted form the channel quality from the base station 4 to the mobile station 3 received from the mobile station 3. As shown in connection with Embodiment 1, an MCS is predicted on the basis of the table that is held in the relay station 1 and that provides a correspondence between channel quality and an MCS. An MCS predicted from the channel quality from the base station 4 to the mobile station 3 is an example parameter (a first parameter) corresponding to the quality of communication between the base station 4 and the mobile station 3. The MCS acquired from the control signal portion of the signal received from the base station 4 is an example parameter (a second parameter) used for a transmission from the base station 4.

When the two MCS levels are in close proximity to each other, the relay station 1 determines that the received signal has been transmitted by means of the direct communication. When the MCS of the received signal is higher than the MCS predicted with regard to the channel from the base station 4 to the mobile station 3 in terms of the degree of multiplicity, the receiving signal is determined to have been transmitted by way of the relay station 1.

In (a) of FIG. 7, the relay station 1 determines that the received signal is a signal that has been directly communicated by means of the frame 3. When the received signal is determined to have been directly communication, the relay station 1 does not send a transmission in the next frame 4. Upon receipt of the signal in the frame 3, the mobile station 3 determines whether or not the received signal includes an error. When the error is included, the mobile station 3 transmits a relay request to the relay station 1 in the frame 4.

The relay station 1 that has received the relay request determines the amount of relay signal from the channel quality from the base station 4 to the mobile station 3 and the channel quality from the relay station 1 to the mobile station 3, and transmits the relay signal to the mobile station 3 by means of a frame 5. Although (a) of FIG. 7 shows an example in which the signal received by the base station 4 includes an error, the communication ends when the signal can have been correctly received.

There will now be provided a case where the base station 4 determines that transmission performed by way of the relay station 1 is better because of poor channel quality from the base station 4 to the mobile station 3. As shown in FIG. 7(b), operations pertaining to the frames 1 and 2 are the same as those shown in FIG. 7(a).

When determined, based on the quality of the three channels, that transmission is performed by way of the relay station 1, the base station 4 transmits a signal in the frame 3 by means of the MCS for the channel from the base station 4 to the relay station 1. The relay station 1 receives the signal transmitted in the frame 3 by the base station 4, thereby acquiring the MCS of the received signal. The relay station 1 compares the thus-acquired MCS with the MCS predicted from the channel quality from the base station 4 to the mobile station 3 received from the mobile station 3.

When the level of the MCS of the received signal is higher (or higher in terms of the degree of multiplicity) as a result of the comparison between the two MCS levels, the relay station 1 determines that the received signal has been transmitted by way of the relay station 1. In order to transmit a relay signal in the frame 4, the relay station 1 determines in the frame 3 the amount of relay signal.

As in (a) of FIG. 7, the amount of relay signal is determined from the quantity of the channel from the base station 4 to the mobile station 3 and the channel quality from the relay station 1 to the mobile station 3. When determined the amount of relay signal (the amount of transmission), the relay station 1 transmits the relay signal to the mobile station 3 in the frame 4.

When determined that the signal of the frame 3 includes an error, the mobile station 3 transmits a relay request in the frame 4. However, since the relay station 1 is in the middle of transmission of the relay signal by means of the same frame, the relay request of the frame 4 is ignored.

[Relay Station Block Diagram]

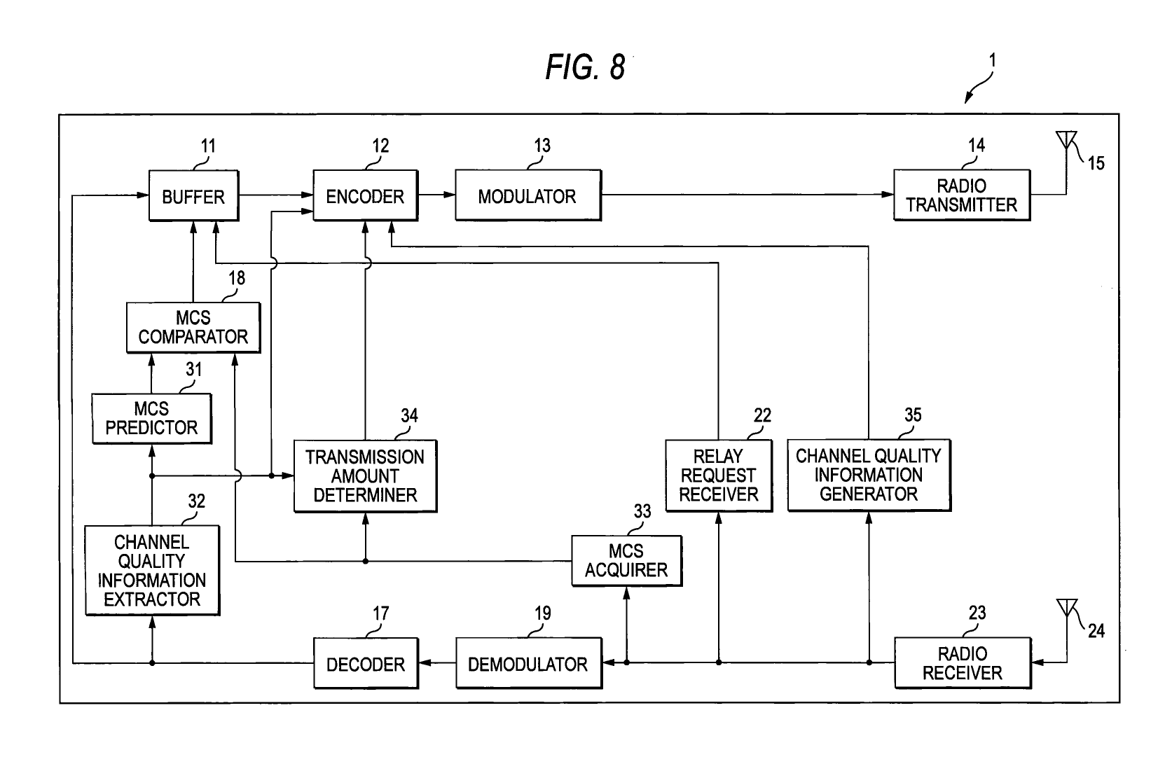

FIG. 8 is a block diagram showing the configuration of the relay station 1 of the embodiment. Explanations about elements having the same functions as those shown in FIG. 3 are omitted.

The channel quality information generator 35 measures the channel quality for the signal received from the base station 4 (the channel quality from the base station 4 to the relay station 1); generates channel quality information for reporting the channel quality to the base station 4; and inputs the information to the encoder 12. The MCS acquirer 33 acquires an MCS from the signal received from the base station 4 and inputs the thus-acquired MCS to the MCS comparator 18 and the transmission amount determiner 34.

The channel quality information extractor 32 extracts, from the signal decoded by the decoder 17, channel quality information showing the channel quality from the base station 4 to the mobile station 3 transmitted from the mobile station 3 and channel quality information showing the channel quality from the relay station 1 to the mobile station 3. The channel quality information extracted by the channel quality information extractor 32 is input to the encoder 12 and the MCS predictor 31. The MCS predictor 31 predicts an MCS level from the input information about the channel quality from the base station 4 to the mobile station 3 and inputs the thus-predicted MCS level to the MCS comparator 18.

The MCS comparator 18 compares an MCS level of the received signal (a signal received from the base station 4) with the predicted MCS level achieved with regard to the channel from the base station 4 to the mobile station 3. When the MCS level of the received signal is equal to or less than the predicted MCS level of the channel from the base station 4 to the mobile station 3, the received signal is determined to be a direct communication. When the MCS level of the received signal is higher (higher in terms of the degree of multiplicity) than the MCS level of the channel from the base station 4 to the mobile station 3 by a given amount, the received signal is determined to be transmitted by way of the relay station 1.

When determined that the received signal is transmitted by way of the relay station 1, the relay station 1 commands the buffer section 11 to output a received signal. Further, the transmission amount determiner 34 determines an amount of transmission of a relay signal from the channel quality from the base station 4 to the mobile station 3, the channel quality from the relay station 1 to the mobile station 3, and the MCS of the received signal (the MCS acquired by the MCS acquirer 33). The thus-determined amount of transmission is input to the encoder 12.

A method for determining the amount of transmission made by the relay station 1 will now be described. The transmission quantity determiner 34 determines the amount of transmission from the MCS of the received signal, the channel quality from the base station 4 to the mobile station 3, and the channel quality from the relay station 1 to the mobile station 3.

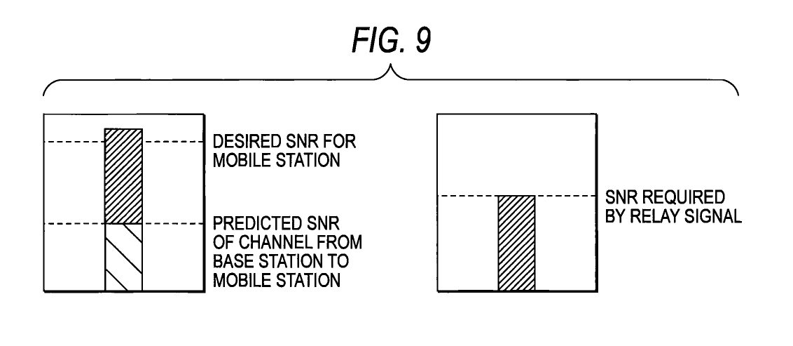

First, as shown in FIG. 9, the transmission amount determiner 34 determines a predicted SNR of the signal received by the mobile station 3 from the MCS of the received signal and the channel quality from the base station 4 to the mobile station 3. The transmission amount determiner 34 compares the predicted SNR with a desired SNR required by the mobile station 3 to correctly receive a signal.

When the predicted SNR of the received signal has not fulfilled the desired SNR, the transmission amount determiner 34 takes as an SNR required for the relay signal, a value that is determined by subtracting a predicted SNR from a desired SNR. Accordingly, the transmission amount determiner 34 determines the amount of transmission of a relay signal by use of a value resultant from subtraction of an SNR, which is determined from the channel quality from the relay station 1 to the mobile station 3, from the SNR determined by the relay signal.

By way of example, an assumption is made that the MCS of a received signal is QPSK 1/2 and that a transmitted signal train is a systematic bit S and a parity bit P1. Table 2 shows a relationship among a value resultant from subtraction of an SNR of the channel from the relay station 1 to the mobile station 3 from the SNR required for the relay signal, a transmission bit string, and a modulation multivalue number.

TABLE 2
TRANSMISSION BIT STRING AND
MODULATED MULTIVALUE NUMBER

| RESULT OBTAINED BY | | |
|---|---|---|
| SUBTRACTING | | |
| SNR[dB] OF CHANNEL | | |
| FROM RELAY STATION | | |
| TO MOBILE STATION | | |
| FROM SNR[dB] | | MODULATION |
| REQUIRED FOR | TRANSMISSION | MULTIVALUE |
| RETRANSMISSION SIGNAL | BIT STRING | NUMBER |
| ~2 | P3 | 64QAM |
| 2~5 | P3 | 16QAM |
| 5~9 | P3 + P4 | 64QAM |
| 9~13 | P3 + P4 | 16QAM |
| 13~16 | P3 + P4 + P5 | 16QAM |
| 16~18 | P3 + P2 | QPSK |
| 18~22 | P3 + P4 + P5 | QPSK |
| 22~ | P3 + P2 | BPSK |

[Flowchart of Relay Station]

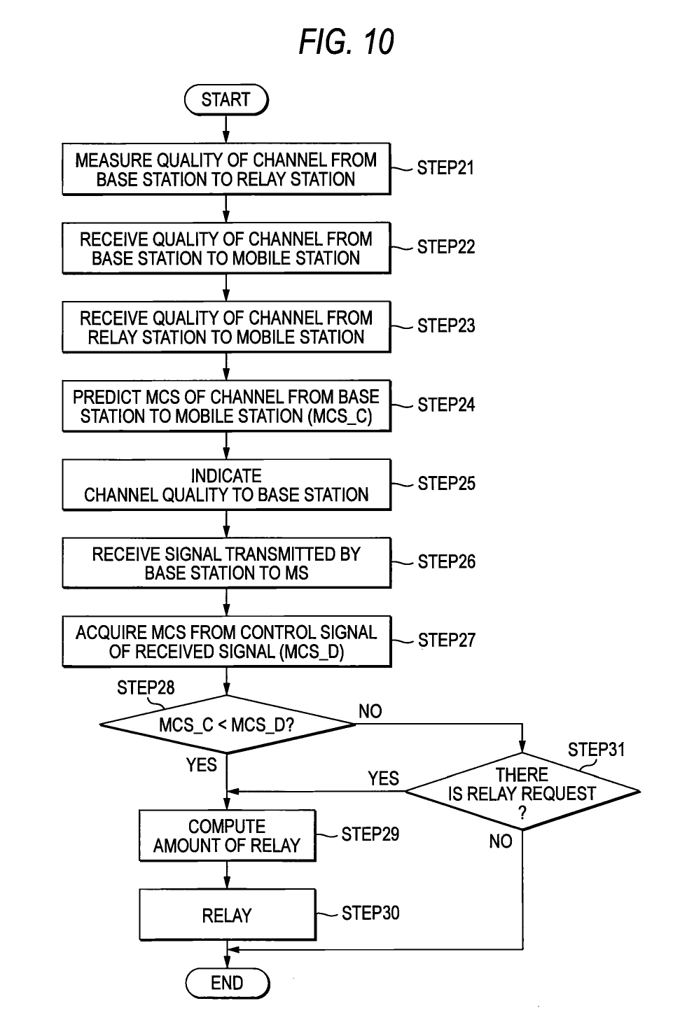

FIG. 10 is a flowchart showing processing procedures of a relay station of the embodiment.

In Step 21, the relay station 1 causes the channel quality information generator 35 to measure the channel quality from the base station 4 to the relay station 1, by means of the signal transmitted from the base station 4. In Step 22, the relay station 1 receives the information about the channel quality from the base station 4 to the mobile station 3 measured by the mobile station 3. In Step 23, the relay station 1 receives the channel quality from the relay station 1 to the mobile station 3 measured by the mobile station 3. Next, in Step 24, the relay station 1 causes the MCS predictor 31 to predict an MCS of the channel from the base station 4 to the mobile station 3 from the channel quality from the base station 4 to the mobile station 3 received in Step 22. Table 1 is used for predicting an MCS. The thus-predicted MCS is taken as MCS_C. In Step 25, the relay station 1 reports the channel quality measured in Step 21 and the channel quality received in Step 22 and Step 23 to the base station 4.

In Step 26, the relay station 1 receives the signal transmitted from the base station 4 to the mobile station 3. In Step 27, the MCS acquirer 33 acquires, from the control signal of the signal received in step 26, the MCS designated for the mobile station 3 by the base station 4. The thus-acquired MCS is taken as MCS_D. In Step 28, the relay station 1 causes the MCS comparator 31 to compare the MCS_C predicted in Step 24 with the MCS_D designated for the mobile station 3 by the base station 4. When the level of the MCS_D is higher than the level of the MCS_C, the degree of multiplicity of the signal is higher than a predicted degree of multiplicity; therefore, the relay station 1 determines a necessity for a relay and proceeds to step 29. In contrast, when the degree of multiplicity of the signal is lower than a predicted degree of multiplicity, the relay station proceeds to step 30. In Step 29, the relay station 1 causes the transmission amount determiner 34 to compute a transmission bit string of a relay signal and a modulation multivalue number from the SNR required for the relay signal and the SNR of the channel from the relay station 1 to the mobile station 3, by use of Table 2.

In Step 30, the relay station 1 transmits a relay signal. In Step 31, the relay station 1 determines whether or not there is a relay request from the mobile station 3. When there is a relay request, the relay station 1 proceeds to step 29. In contrast, when there is no relay request, the relay station proceeds to an end.

[Base Station Block Diagram]

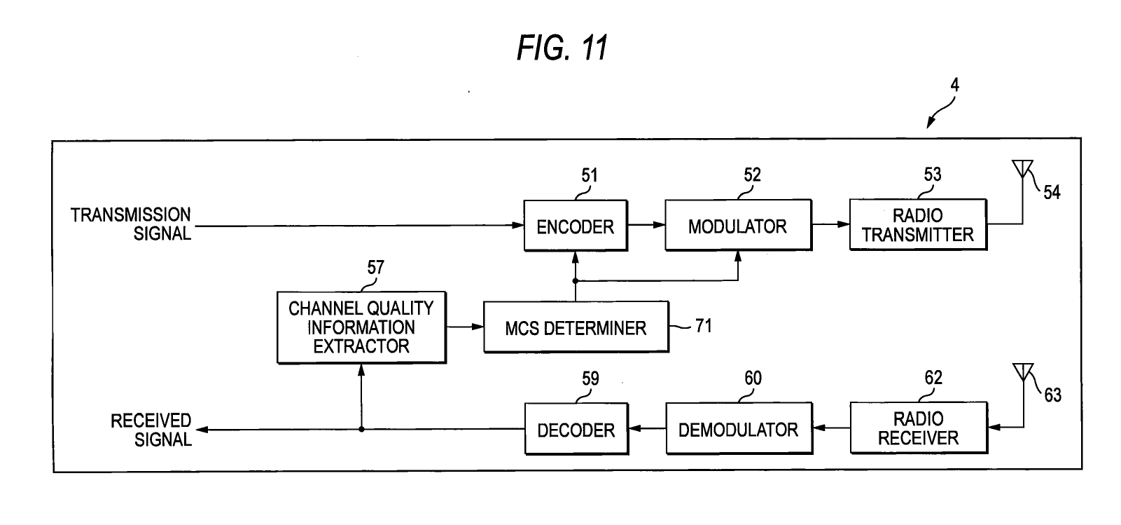

FIG. 11 is a block diagram showing the configuration of the base station 4 of the embodiment. Explanations of blocks whose functions are equivalent to those of the relay station 1 shown in FIG. 5 are omitted. The channel quality information extractor 57 extracts, from the signal received from the relay station 1, the information about the channel from the base station 4 to the mobile station 3, information about the channel quality from the base station 4 to the mobile station 3, information about the channel quality from the base station 4 to the relay station 1, and information about the channel quality from the base station 1 to the mobile station 3.

The channel quality information extracted by the channel quality information extractor 57 is input to an MCS determiner 71. From the quality of the three channels, the MCS determiner 71 determines whether to adopt the MCS for a direct transmission to the mobile station 3 or a transmission relayed by way of the relay station 1; and provides the thus-determined MCS to the encoder 51 and the modulator 52 as a command.

In the present embodiment, the uplink from the mobile station 3 to the base station 4 is described as being relayed by way of the relay station 1 but may also be a direct communication.

In the present embodiment, the example shown in Table 2 is used as a relationship among the value resultant from subtraction of the SNR[dB] of the channel from the relay station 1 to the mobile station 3 from the SNR[dB] required for the relay signal, a transmission bit string, and a modulation multivalue number. However, a table including different numerals may also be used.

In the present embodiment, the predicted MCS regarding the channel from the base station 4 to the mobile station 3 is compared with the MCS of the received signal. However, as in the case of inversion of the uplink of Embodiment 1 to the downlink, it may also be possible to compare the predicted MCS of the channel from the base station 4 to the relay station 1 with the MCS of the received signal; and to immediately transmit a relay signal so long as the MCS of the received signal is a value near the predicted MCS of the channel from the base station 4 to the relay station 1. A determination as to whether or not the value of the MCS of the received signal is a value near the predicted MCS includes a determination result showing that both values are totally identical with each other. A magnitude relation may also be used even for the comparison at this time. In connection with a comparison performed to determine a magnitude relation, a value determined by adding a certain level to the level of a received signal or a value determined by subtracting a certain level from the level of a received signal may also be used for the comparison.

In the respective embodiments, the relay station 1 is described as transmitting a relay signal. However, when the quality of direct transmission is determined to be a certain level or lower, the original signal may also be relayed.

The relay signal may also be generated by means of HARQ that is a combination of an FEC with a retransmission (ARQ). At this time, a Chase combination method that is an HARQ type I or an IR (Incremental Redundancy) method that is an HARQ type II may also be used for a relay signal to be generated. When the Chase combination method is used, a receiving end combines an original signal with a relay signal at the maximum ratio, thereby enabling enhancement of an error rate characteristic.

When the IR method is used, a transmission end transmits a signal that is partially erased according to an erasure rule that differs according to the number of relay operations; and a receiving end combines an original signal with the partially-erased signal that is different from the original signal, thereby performing error correction decoding operation.

In the respective embodiments, the mobile station 3 combines the first transmission with the signal transmitted from the relay station 1. However, when receiving quality of the first received signal is low, the received signal may also be generated by use of only the relay signal.

In the respective embodiments, still another relay station may also be present between the relay station 1 and the base station 4 or between the mobile station 3 and the relay station 1. Further, the base station 4 may also receive the signal from the mobile station 3 by way of a plurality of relay stations.

In the respective embodiments, the base station 4 is sometimes represented as Node B, and the mobile station 3 is sometimes represented as UE. The relay station 1 of the respective embodiments is often called a repeater, a simplified base station, a cluster head, and the like. The respective embodiments have been described by means of taking, as an example, a case where the present invention is made up of hardware. However, the present invention may also be implemented by software. In the respective embodiments, channel quality information fed back to the base station 4 or the relay station 3 is often called a CQI (Channel Quality Indicator).

Respective functional blocks used for describing the respective embodiments are implemented in the form of an LSI that is typically an integrated circuit. The blocks may also be discretely packaged into a single chip or may also be packaged in a single chip so as to include portions or all of the functional blocks. Although an LSI is herein referred to as an LSI, the integrated circuit may also be referred to as an IC, a system LSI, a super LSI, and an ultra LSI in some occasions according to the degree of integration.

The technique for realizing an integrated circuit is not limited to the LSI and may also be implemented by means of a custom-designed circuit or a general-purpose processor. An FPGA (Field Programmable Gate Array) that can be programmed after manufacture of an LSI and a reconfigurable processor that allows reconfiguration of connections or settings of circuit cells in the LSI may also be utilized.

Moreover, if a technique for realizing an integrated circuit in place of an LSI appears as a result of advance of the semiconductor technique or by virtue of another technique derived from the semiconductor technique, the functional blocks may also naturally be integrated by use of the technique. An adaptation of biotechnology, or the like, is potentially possible.

The present invention yields an advantage of the ability to enhance a throughput characteristic and the degree of multiplicity of an MCS without a necessity for a special additional function and can be utilized as a radio communication method, a radio communication apparatus, and the like.

Although the present invention has been described in detail or by reference to the specific embodiments, it is manifest to those skilled in the art that the present invention is susceptible to various alterations or modifications without departing the spirit and scope of the invention.

The present patent application is based on Japanese Patent Application (JP-A-2007-126678) filed on May 11, 2007, the contents of which are incorporated herein by reference.

### INDUSTRIAL APPLICABILITY

In a radio communication apparatus of the present invention, the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code, and are useful for use with the radio communication apparatus, and the like.

1. A radio communication apparatus for relaying a signal between a mobile station and a base station, the radio communication apparatus comprising:
a unit for determining quality of an uplink from the mobile station to the base station;
a unit for generating an uplink relay signal based on the signal received from the mobile station when the quality of the uplink is determined to be poor; and
a unit for transmitting the generated uplink relay signal to the base station.

2. (canceled)

3. The radio communication apparatus according to claim 2, comprising:
a channel quality measurement section that measures, based on the signal received from the mobile station, channel quality from the mobile station to the radio communication apparatus;
an MCS predictor that predicts, based on the channel quality measured by the channel quality measurement section, an MCS to be used for a communication from the mobile station to the radio communication apparatus;
an MCS extractor that extracts, from the signal received from the base station,
an MCS indicated to the mobile station by the base station; and
an MCS comparator that compares a level of the MCS predicted by the MCS predictor with a level of the MCS extracted by the MCS extractor, and that determines the quality of the uplink to be poor when the two MCS levels are in close proximity to each other.

4. The radio communication apparatus according to claim 2, wherein the radio communication apparatus does not transmit the uplink relay signal until receiving a relay request from the mobile station when channel quality from the mobile station to the base station is determined to be high.

5. A radio communication apparatus for transmitting signals to a mobile station via a relay station, the radio communication apparatus comprising:
a unit for determining quality of an uplink from the mobile station to the base station;
a unit for indicating to the mobile station an MCS in which a degree of multiplicity appropriate for a communication with the relay station is set when the quality of the uplink is determined to be poor.

6. The radio communication apparatus according to claim 5, comprising a unit for indicating to the mobile station an MCS from the mobile station to the relay station when the quality of the uplink is determined to be poor.

7. The radio communication apparatus according to claim 5, comprising:
a channel quality measurement section that has a function of measuring, based on a signal received from the mobile station, channel quality from the mobile station to the radio communication apparatus and a function of measuring, based on a signal received from the relay station, channel quality from the relay station to the radio communication apparatus;
a channel quality information extractor that extracts, from the signal received from the relay station, channel quality from the mobile station to the relay station; and
an MCS indication signal generator that determines an MCS to be indicated to the mobile station, based on the channel quality for a communication from the mobile station to the radio communication apparatus and the channel quality for a communication from the relay station to the radio communication apparatus, which are measured by the channel quality measurement section, and also based on the channel quality for a communication from the mobile station to the relay station extracted by the channel quality information extractor.

8. A radio communication apparatus for relaying a signal between a mobile station and a base station, the radio communication apparatus comprising:
a unit for determining quality of a downlink from the base station to the mobile station;
a unit for generating a downlink relay signal based on the signal received from the base station when the quality of the downlink is determined to be poor; and
a unit for transmitting the generated downlink relay signal to the mobile station.

9. (canceled)

10. The radio communication apparatus according to claim 9, comprising:
a channel quality information generator that measures, based on the signal received from the base station, channel quality from the base station to the radio communication apparatus, to thus generate channel quality information to be indicated to the base station;
an MCS acquirer that acquires an MCS of the signal received from the base station;
a channel quality information extractor that extracts channel quality information showing channel quality from the base station to the mobile station transmitted from the mobile station, and channel quality information showing channel quality from the radio communication apparatus to the mobile station;
an MCS predictor that predicts a level of an MCS based on the channel quality information from the base station to the mobile station extracted by the channel quality information extractor; and
an MCS comparator that compares a level of the MCS predicted by the MCS predictor with the level of the MCS acquired by the MCS section, and that determines the quality of the downlink to be poor when the MCS level predicted by the MCS predictor is higher than the MCS level acquired by the MCS acquirer by a given amount or more.

11. The radio communication apparatus according to claim 10, comprising a transmission amount determiner that determines an amount of transmission of the downlink relay signal based on channel quality from the base station to the mobile station, channel quality from the radio communication apparatus to the mobile station, and the MCS acquired by the MCS acquirer.

12. A radio communication method for relaying a signal between a mobile station and a base station by a relay station, the radio communication method comprising the steps of:
determining by the relay station, channel quality from the mobile station to the base station; and
generating a relay signal based on a signal received from the mobile station and transmitting the relay signal to the base station when the channel quality is determined to be poor.

13. The radio communication method according to claim 12, comprising the steps of:
comparing by the relay station, an MCS assigned to a communication from the mobile station to the base station with an MCS predicted based on channel quality from the mobile station to the relay station; and
determining the channel quality from the mobile station to the base station to be poor when a level of the MCS assigned to the communication from the mobile station to the base station and a level of the MCS predicted based on the channel quality from the mobile station to the relay station are in close proximity to each other.

14. The radio communication method according to claim 12, wherein the relay station does not perform relaying operation until a relay request is issued by the mobile station when the channel quality from the mobile station to the base station is determined to be high.

15. The radio communication method according to claim 12, wherein, when determined that the channel quality from the mobile station to the base station is poor, the base station notifies the mobile station of an MCS having a modified degree of multiplicity.

16. The radio communication method according to claim 15, wherein the MCS having the modified degree of multiplicity that is to be indicated to the mobile station is an MCS of the communication from the mobile station to the relay station.

17. A radio communication method for relaying a signal between a base station and a mobile station by a relay station, the radio communication method comprising the steps of:
determining by the relay station, channel quality from the base station to the mobile station; and
generating a relay signal based on a signal received from the base station and transmitting the relay signal to the mobile station when the channel quality is determined to be poor.

18. The radio communication method according to claim 17, comprising the steps of:
comparing by the relay station, an MCS of a signal transmitted from the base station with an MCS predicted from channel quality from the base station to the mobile station; and
determining the channel quality from the base station to the mobile station to be poor when a difference between a level of the MCS of the signal transmitted from the base station and a level of the MCS predicted based on the channel quality from the base station to the mobile station is a given amount or more and when the MCS level of the signal transmitted by the base station is low.

19. The radio communication method according to claim 17, comprising the steps of:
receiving by the relay station, channel quality indicated to the base station by the mobile station;
predicting receiving quality achieved by the mobile station based on the received channel quality and an MCS of a signal transmitted by the base station to the mobile station; and
determining an amount of transmission of a relay signal so as to fulfill desired receiving quality of the mobile station.

20. A radio communication apparatus that serves as a relay station for relaying a communication between a mobile station and a base station, the apparatus comprising:
an acquisition unit that acquires quality of the communication between the mobile station and the relay station;
a selection unit that selects a first parameter corresponding to the acquired communication quality;
a receiving unit that receives information including a second parameter designated by the base station so as to be used in a transmission from the mobile station;
a determination unit that determines whether or not a value of the second parameter is close to a value of the first parameter; and
a transmission unit that relays the signal transmitted from the mobile station to the base station when the determination is affirmative.

21. The radio communication apparatus according to claim 20, wherein the transmission unit inhibits a relay transmission to the base station until a relay request is received from the base station when the determination is negative.

22. The radio communication apparatus according to claim 20, wherein the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code.

23. A radio communication apparatus that serves as a relay station for relaying a communication between a base station and a mobile station, the apparatus comprising:
a receiving unit that receives from the mobile station information about quality of a communication between the base station and the mobile station and that further receives from the base station information about a second parameter used in a transmission from the base station;
a selection unit that selects a first parameter corresponding to the communication quality;
a determination unit that determines whether or not a value of the second parameter is to be used in a communication channel that is higher in quality than a communication channel in which a value of the first parameter or a value near the value of the first parameter is used; and
a transmission unit that relays the signal transmitted by the base station to the mobile station when the determination is affirmative.

24. The radio communication apparatus according to claim 23, wherein the transmission unit inhibits a relay transmission to the mobile station until a relay request is received from the mobile station when the determination is negative.

25. The radio communication apparatus according to claim 23, wherein the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code.

26. A radio communication apparatus that serves as a relay station for relaying a communication between a base station and a mobile station, the apparatus comprising:
an acquisition unit that acquires quality of the communication between the base station and the relay station;
a selection unit that selects a first parameter corresponding to the acquired communication quality;
a receiving unit that receives, from the base station, information about a second parameter used in a transmission originated from the base station;
a determination unit that determines whether or not a value of the second parameter is close to a value of the first parameter; and
a transmission unit that relays the signal transmitted from the base station to the mobile station when the determination is affirmative.

27. The radio communication apparatus according to claim 26, wherein the transmission unit inhibits a relay transmission to the mobile station until a relay request is received from the mobile station when the determination is negative.

28. The radio communication apparatus according to claim 26, wherein the first parameter and the second parameter are represented by use of any one or more of types; namely, an MCS level, a CQI, an SNR, an SIR, an SINR, a CIR, a CNR, a CINR, an RSSI, received power, interference power, an error rate, a transmission rate, a throughput, a prediction error ratio, traveling speed of a mobile station, intensity of channel fluctuation, and an error correction code.
